(19) United States
(12) Patent Application Publication
(10) Pub. No.: US 2014/0131346 A1
(43) Pub. Date: May 15, 2014

(54) CONVECTION COOKING APPLIANCE WITH A LOW-VOLTAGE DIRECT CURRENT MOTOR

(71) Applicant: Johnson Electric S.A., Murten (CH)

(72) Inventors: Siu Chung YIP, Hong Kong (CN); Michael Yui Ko WONG, Hong Kong (CN)

(73) Assignee: Johnson Electric S.A., Murten (CH)

(21) Appl. No.: 14/076,774

(22) Filed: Nov. 11, 2013

(30) Foreign Application Priority Data
Nov. 9, 2012 (CN) 201220590848.0
Nov. 7, 2013 (CN) 201320704440.6

(51) Int. Cl. H05B 6/64

(52) U.S. Cl. CPC H05B 6/6473
USPC 219/681; 219/400

(57) ABSTRACT

A cooking appliance (10) includes a housing (12), a food process area (14) inside the housing, a heat source (22, 504), a low voltage DC motor (18, 510, 610) driving an impeller (16) disposed upstream of the heat source to circulate air and convectively transfer heat for preparing food In one embodiment, the heat source (22), serving as a voltage divider, and a shunt (24), cooperate to regulate the voltage and current input for driving the low voltage DC motor (18). In another embodiment, the heat source (504, 604) is connected across an AC power source (502, 602) and a voltage divider (506, 606) regulates the voltage input to the low voltage DC motor (510, 610).

### CROSS REFERENCE TO RELATED APPLICATION(S)

This application claims the benefit of Chinese patent application serial no. 201220590848.0 having a filing date of Nov. 9, 2012. This application also claims the benefit of Chinese patent application serial no. 201320704440.6, entitled “Cooking Apparatus” and filed on Nov. 7, 2013. The content of the aforementioned patent applications is hereby expressly incorporated by reference in its entirety for all purposes.

### BACKGROUND

Conventional deep flying has become less popular recently because of its potential negative impact on health and further because of convective heat transfer becoming popular in modern cooking. Cooking appliances utilizing convective heat transfer may transfer heat more efficiently than conventional broiling or baking ovens and hence finish food preparation more rapidly are more energy efficient. Conventional convection cooking appliances usually use high-voltage direct current (DC) motors which typically use small diameter wires for their field windings or field coils. The small diameter wires coupled with high operating voltages result in high current densities and thus significant Ohmic heating (also known as Joule heating or resistive heating and used interchangeably hereinafter). As a result, conventional convection cooking apparatus with high-voltage direct current motors often lead to high temperatures in the motor area.

High temperatures often lead to intermittent performance issues or even accelerated deterioration of various components (e.g., the field winding and other components in the vicinity of the field winding) due to excessive heat. To further acerbate the high temperature issues often found in conventional cooking appliances with high-voltage motors, high operating voltages may increase the possibility of electric arcing between the commutator and the brushes during commutation and thus compromise the integrity, reliability, performance, or service life of the motor. Small diameter wires such as enameled copper wires are also fragile and thus prone to damages during the manufacturing process to form the field windings of the motor. Therefore, there exists a need for an improved convection cooking apparatus with reduced heat generation, less possibility of electric arcing, lower operating temperatures, and more robust components.

### SUMMARY OF THE INVENTION

Various first embodiments are directed at cooking appliances that use convective heat transfer to prepare food contained therein to promote more even and efficient heating for food preparation. In some embodiments, a cooking appliance including a convection cooking appliance may comprise a heat generating source or a heat source (e.g., one or more heating elements of the resistive heating type, of the radiation type, or of various other types of heating) that generates heat for preparing food, and an impeller that may be placed upstream or downstream of the heat source to circulate air flow past the heat source to absorb the heat generated by the heat source for preparing the food. The cooking appliance may further include a rectifier having an input that is electrically coupled to the heat source and an output as well as a motor that is electrically connected to the output of the rectifier and mechanically coupled to the impeller. The rectifier may convert alternating current (AC) power source into direct current (DC) power source to drive the motor.

The cooking appliance may further optionally comprise one or more first air passageways through a food process area within the housing of the cooking appliance and communicating with the outlet of the impeller and the heat source. In addition or in the alternative, the cooking appliance may further include one or more second air passageways through which at least a portion of the air flow exiting the container of the cooking appliance may be further guided to flow. At least an end portion of some of the first air passageways substantially encloses the one or more exhausts of the impeller with a minimum or a reduced gap to improve or enhance the efficiency of the impeller while accommodating the manufacturing slacks, tolerances, or allowances in some embodiments. In addition or in the alternative, at least an end portion of some of the second air passageways may substantially enclose the inlet of the impeller with a minimum or a reduced gap to improve or enhance the efficiency of the impeller while accommodating the manufacturing slacks, tolerances, or allowances in some embodiments.

The motor in the cooking appliance may be coupled to the heat source in series in some embodiments or in parallel on the DC side of the rectifier in some other embodiments. The motor may include a low-voltage direct current (LVDC) motor and thus may have larger diameter wires in its field winding or field coil due to higher operating current through the motor than a conventional motor providing the same power output. The larger diameter wires in the low-voltage motor may further be devised to reduce the electric current density flowing through the motor and thus reduces the undesired Ohmic heating and possible electric arcing between, for example, the commutator and the brushes of the motor during commutation. The motor may operate under lower temperatures due to reduced Ohmic heating and may thus have better reliability and performance and a longer service life. The larger diameter wires in the field winding or field coil may further improve the life, performance, and reliability of the motor.

The apparatus may further include a shunt, one or more dummy devices, or other similar electrical components or devices (collectively shunt) to control the operating current or the operating voltage the motor to a desired or required level. A shunt may be electrically coupled to the motor in parallel on either the alternating current side or the direct current side of the rectifier to serve as a current divider for the motor. In the alternative, a shunt may be electrically coupled to the motor in series on either the alternating current side or the direct current side of the rectifier to serve as a voltage divider for the motor. In some embodiments where a shunt may be disposed on the alternating side of the rectifier, the shunt may include one or more resistive elements, one or more capacitive elements, one or more inductive elements, or any combinations thereof. In some embodiments where a shunt is disposed on the direct current side of the rectifier, the shunt may include one or more resistive elements including one or more heating elements, one or more electrical filaments, or any combinations thereof.

More details about the rotatory device are described in the Detailed Description section with reference to FIGS. 1-6 as provided below.

### BRIEF DESCRIPTION OF THE FIGURES

The drawings illustrate the design and utility of embodiments, in which similar elements are referred to by common reference numerals. These drawings are not necessarily drawn to scale. In order to better appreciate how the above-recited and other advantages and objects are obtained, a more particular description of the embodiments will be rendered which are illustrated in the accompanying drawings. These drawings depict only exemplary embodiments and are not therefore to be considered limiting of the scope of the claims.

FIG. 1 illustrates a schematic diagram of an exemplary cooking appliance in some embodiments.

FIG. 2 illustrates a schematic circuit diagram of the exemplary cooking appliance illustrated in FIG. 1 in some embodiments.

FIG. 3 illustrates another schematic circuit diagram of the exemplary cooking appliance illustrated in FIG. 1 in some embodiments.

FIG. 4 illustrates a perspective view of an exemplary cooking appliance illustrated in FIG. 1 in some embodiments.

FIG. 5 illustrates another schematic diagram of a cooking appliance in some embodiments.

FIG. 6 illustrates another schematic diagram of a cooking appliance in some embodiments.

### DETAILED DESCRIPTION

Various features are described hereinafter with reference to the figures. It shall be noted that the figures are not necessarily drawn to scale, and that the elements of similar structures or functions are represented by like reference numerals throughout the figures. It shall also be noted that the figures are only intended to facilitate the description of the features for illustration and explanation purposes, unless otherwise specifically recited in one or more specific embodiments or claimed in one or more specific claims. The drawings figures and various embodiments described herein are not intended as an exhaustive illustration or description of various other embodiments or as a limitation on the scope of the claims or the scope of some other embodiments that are apparent to one of ordinary skills in the art in view of the embodiments described in the Application. In addition, an illustrated embodiment need not have all the aspects or advantages shown in other descriptive or illustrated embodiments.

Some first embodiments are directed at cooking appliances that use convective heat transfer to prepare food contained therein to promote more even and efficient heating for food preparation. In some embodiments, a cooking appliance including a convection cooking appliance may comprise a heat generating source or a heat source (e.g., one or more heating elements of the resistive heating type, of the radiation type, or of various other types of heating) that generates heat for preparing food, and an impeller that is placed upstream of the heat source to circulate air flow past the heat source to absorb the heat generated by the heat source for preparing the food. The cooking appliance may be selected from a group consisting of a convection oven, a convection microwave, a convection fryer, and a food dehydrator.

The heat source may include one or more heating elements selected from a group consisting of one or more resistance heating elements, one or more lamps, one or more infrared heating components, one or more encapsulated heating elements, and a combination of two or more of the one or more resistance heating elements, the one or more lamps, the one or more infrared heating components, and the one or more encapsulated heating elements (e.g., a resistive heating element encapsulated or embedded in an insulator). In some embodiments where the cooking appliance includes an encapsulated heating element, the encapsulated heating element may be encapsulated, embedded, or molded within some thermally conductive polymeric or ceramic material having a certain thickness sized to prevent dielectric breakdown and a thermal expansion characteristic closely matching that of the metallic heating wire therewithin.

The heat source may be disposed within a housing of the cooking appliance and connected to an alternating current source external to the cooking appliance. The impeller may also be disposed in the housing and including an inlet and an outlet. The impeller may be optionally disposed between an internal sidewall of the housing and an external sidewall of a food processing area within the housing in some of the first embodiments. In addition, the cooking appliance may further include a rectifier having an input electrically coupled to the heat source and an output and a motor electrically connected to the output of the rectifier and mechanically coupled to the impeller. In some of the immediately preceding embodiments, the motor may include a low-voltage direct current motor having an input voltage in a range from 12 volts to 36 volts. The motor may optionally include a field winding wound on at least a portion of a rotor of the motor and comprising a wire having a diameter within a range between 0.2 millimeter (mm) and 0.5 mm. In addition or in the alternative, the rectifier may have an output direct current voltage less than or equal to 36 volts.

The apparatus further includes a motor which is coupled to the heat source in series in some embodiments or in parallel in some other embodiments. The motor may include a low-voltage direct current (LVDC) motor and thus may have larger diameter wires in the field winding or field coil of the motor due to higher operating current through the motor than a conventional motor providing the same power output. The larger diameter wires in the low-voltage motor may further reduce the electric current density flowing through the motor and thus reduces the undesired Ohmic heating and possible electric arcing between, for example, the commutator and the brushes of the motor during commutation.

In some embodiments, the cooking appliance may further include a current shunt electrically coupled to the heat source and to the input of the rectifier. In some other embodiments, the cooking appliance may include a current shunt electrically coupled to the output of the rectifier. In addition or in the alternative, the cooking appliance may optionally include a voltage divider having a first terminal electrically coupled to heat source and a second terminal electrically coupled to the input of the rectifier. In some embodiments, the cooking appliance may include a voltage divider having a first terminal electrically coupled to the output of the rectifier and a second terminal coupled the motor. In some of the first embodiments, the cooking appliance may optionally include a protection circuitry including a temperature sensor operatively coupled to the alternating current source and at least a portion of the motor.

The motor may operate under lower temperatures due to reduced Ohmic heating and may thus have better reliability and performance and a longer service life. The larger diameter wire in the field winding or field coil may further improve the life, performance, and reliability of the motor. The apparatus may include a rectifier to convert the alternating current into direct current for the motor, which in turn drives an impeller to provide convective heat transfer. The apparatus may further include a shunt or other similar electrical components or devices to control the operating current or the operating voltage the motor to a desired or required level. A shunt may be electrically coupled to the motor in parallel on either the alternating current side or the direct current side of the rectifier to serve as a current divider for the motor. In the alternative, a shunt may be electrically coupled to the motor in series on either the alternating current side or the direct current side of the rectifier to serve as a voltage divider for the motor. In some embodiments where a shunt is situated on the alternating side of the rectifier, the shunt may include a resistive element, a capacitive element, an inductive element, or any combinations thereof. In some embodiments where a shunt is situated on the direct current side of the rectifier, the shunt may include a resistive element.

In addition or in the alternative, at least a portion of the air flow exiting the container of the apparatus may be further guided to flow through one or more other air passageways to circulate back to the inlet of the impeller such that the air flow in the apparatus occurs in a more controlled manner At least an end portion of some of the first air passageways substantially encloses the one or more exhaust with a minimum or a reduced gap to improve or enhance the efficiency of the impeller while accommodating the manufacturing slacks, tolerances, or allowances in some embodiments. In addition or in the alternative, at least an end portion of some of the second air passageways substantially encloses the inlet of the impeller with a minimum or a reduced gap to improve or enhance the efficiency of the impeller while accommodating the manufacturing slacks, tolerances, or allowances in some embodiments.

In some of these embodiments, the cooking appliance further comprises one or more first air passageways through a food process area in the housing and communicating with the outlet of the impeller and the heat source, wherein at least a portion of the air flow compressed by the impeller is guided to flow in the one or more air passageways to reach a container having food placed therein or thereupon to cause forced convective heat transfer between the air flow and the food for preparing the food. The cooking appliance may also optionally include one or more second air passageways communicating with the inlet of the impeller and the heat source disposed downstream of the impeller disposed between an internal sidewall of the housing and an external sidewall of a food container disposed within the housing, wherein at least a portion of the one or more second air passageways at least partially encloses the inlet of the impeller.

A container may include an opening and accommodate at least a portion of food placed therein in some embodiments. A container (or a food container) may comprise one or more racks or one or more shelves upon which food to be prepared by the cooking appliance may be placed in some other embodiments. Yet in some other embodiments, a container may include a combination of an opening to accommodate at least a portion of food placed therein and one or more shelves or racks upon which food may be placed. Therefore, a container may or may not necessarily refer to a component that contains the food to be processed in various cooking apparatuses described herein.

Some second embodiments are directed at a convection cooking process that comprises the act of electrically connecting a heat source disposed within a housing of a cooking appliance to an alternating current source, the act of converting an alternating current from the alternating current source to a direct current by electrically coupling an input of a rectifier to the alternating current source, the act of electrically coupling a direct current motor to an output of the rectifier, the act of driving an impeller with the direct current motor to circulate air flow past the heat source and through a food processing area in the housing of the cooking appliance, and the act of regulating an operating characteristic for the direct current motor. In some of the second embodiments, the act of regulating the operating characteristic may include the act of electrically coupling a shunt in parallel with the direct current motor to the output of the rectifier.

In some other embodiments, the act of regulating the operating characteristic may comprise electrically coupling a shunt in parallel with the input of the rectifier to the heat source. The act of regulating the operating characteristic may optionally comprise the act of electrically coupling a voltage divider in series with the input of the rectifier to the heat source. In some of the second embodiments, the act of the act of electrically coupling the voltage divider includes the act of selecting the voltage divider from a group consisting of a resistive device, a capacitive device, an inductive device, and a combination of two or more of the resistive device, the capacitive device, and the inductive device. In some of the second embodiments, the convection cooking process may further include the act of guiding the air flow through one or more first air passageways communicating an outlet of the impeller and the heat source, at least a portion of the one or more first air passageways situated between an internal sidewall of the housing and an external sidewall of a food processing area within the housing and the act of guiding the air flow through one or more second air passageways that enclose at least a portion of an inlet of the impeller.

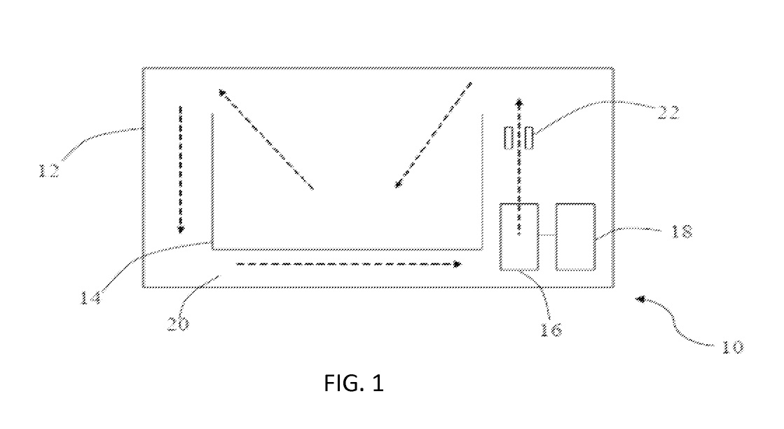

FIG. 1 illustrates a schematic diagram of an exemplary cooking appliance 10 in some embodiments. More specifically, FIG. 1 illustrates the schematic diagram of an exemplary cooking appliance 10 including a convection oven, a convection microwave, a food dehydrator, or any appliances utilizing convective heat transfer for food preparation. In some of these embodiments illustrated in FIG. 1, the exemplary cooking appliance 10 includes a housing 12 that accommodates the internal components disposed therein, a food processing area 14 disposed within the housing 12 to hold the food for cooking, a fan or impeller 16 to cause forced convection to distribute heat for food preparation via convective heat transfer, and a motor 18 that drives the impeller 16. The exemplary cooking appliance 10 may further include one or more air passageways 20 disposed between the housing 12 and the food processing area 14 to better circulate air flow within the unoccupied space in the exemplary cooking appliance 10.

In some of the immediately preceding embodiments, the impeller 16 includes an intake to draw air along an axial direction of the impeller shaft (not shown) to which multiple vanes or blades are attached. In addition, the impeller 16 may further include one or more outlets arranged in the circumferential direction of the impeller 16 for compressed air flow to exit for circulation. The impeller 16 may include an open type having no cover in some embodiments, a closed type having a cover in some other embodiments, and a semi-open type in yet some other embodiments. The choice of the type of impeller 16 may be based at least in part upon the flow rate required or desired, the designs of components other than the impeller 16 of the cooking appliance 10, the free space available for forced convective heat transfer, the electrical input or driver (e.g., motor 18) for the impeller 16, the operational speeds of the impeller 16, the need for more than one stage in the operations, or any combinations thereof.

In some embodiments, the impeller 16 comprises a centrifugal type impeller substantially similar to that in a centrifugal type compressor. In some embodiments, the impeller 16 may include an axial flow type impeller to cause increased volumetric flow rate for the compressed air flow. The use of a radial flow type impeller is also contemplated in some other embodiments. The exemplary cooking appliance 10 may further include a heat source disposed downstream to the impeller 16 in some of these embodiments illustrated in FIG. 1. In some of the immediately preceding embodiments, the heat source comprises one or more heating elements 22 such that the air flow driven by the impeller 16 may carry some of the heat generated by the heating element 22 to cause forced convective transfer to prepare the food in the food processing area 14. In the alternative, the cooking appliance 10 may include a heat source disposed upstream of the impeller 16 in some other embodiments.

During the operation of the cooking appliance 10, the impeller 16 draws air into the intake, increases the flow or pressure of the air flow, and propels the compressed air through its one or more outlets. The compressed air flow contacts the heating elements 22 disposed downstream of the impeller 16 and absorbs the generated heat in some embodiments. The compressed air flow is circulated within the free space (e.g., in the unoccupied space within the housing 12 or the food processing area 14 or along the one or more air passageways 20 between the housing 12 and the food processing area 14 and downstream of the one or more outlets of the impeller 16) by the operation of the impeller 16. At least a part of the compressed air finally enters at least a portion of the food processing area 14 to transfer the heat absorbed in the at least a part of the compressed air flow into the food in the food processing area 14. Due to the operation of the impeller 16, the compressed air flow may then circulate back to the impeller 16 through, for example, the one or more air passageways 20.

In some of these immediately preceding embodiments, the impeller 16, the food processing area 14, and the housing 12 are designed or configured to maintain a close fit (e.g., with a minimal gap achievable under the manufacturing tolerances, slacks, or allowances) between the external boundaries of the impeller 16 and the immediately neighboring sidewalls of the food processing area 14 and of the housing 12. In some of these embodiments, the intake, the one or more outlets, or both of the impeller 16 are substantially enclosed by specially designed air ducts or channels to achieve a more efficient air circulation or air flow within the free space of the exemplary cooking appliance 10. It shall be noted that the term “substantially” or “substantial” (e.g., “substantially enclose”) is used herein to refer to a feature that is intended or designed to be of certain characteristic such as a magnetic flux ring substantially enclosing the permanent magnets. Nonetheless, the manufacturing or design slacks, manufacturing tolerances, material movement or deformation due to various physical processes (e.g., material movement or deformation due to heat generated during the manufacturing process), or the normal wear and tear may cause the feature to deviate from the intended profile or dimensions.

A part of the compressed air flow may circulate into and out of the food processing area 14 to exchange heat with the food placed therein and subsequently enter one or more other air passageways that lead to the intake of the impeller 16 in some of the embodiments illustrated in FIG. 1. In these embodiments, the air flow circulates inside the exemplary cooking appliance 10 in a more controlled manner to achieve higher efficiency in heat transfer and better evenness in preparing the food placed in or on the food processing area 14. In some embodiments, an air passageway may include an open channel having a bottom surface and two sidewall sections constraining the air flow therein, a closed channel having a bottom surface, two sidewall sections, and a top cover constraining the air flow therein, an unconstrained free space, or any combination of an open channel for zero or more portions of the air passageway, a closed channel for zero or more other portions of the air passageway, and an unconstrained free space for one or more portions of the air passageway.

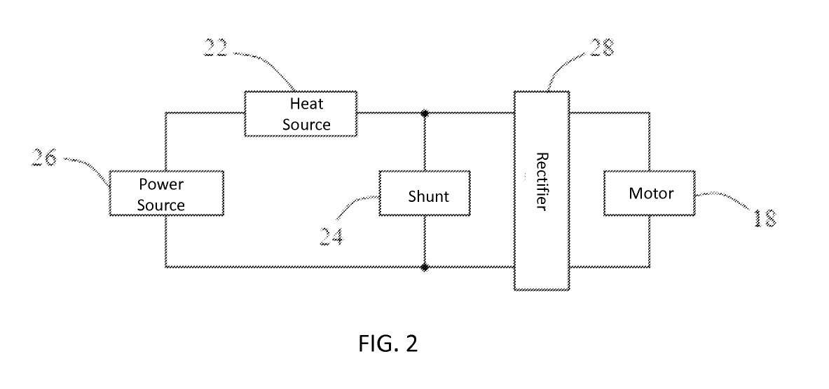

FIG. 2 illustrates a schematic circuit diagram of the exemplary cooking appliance 10 illustrated in FIG. 1 in some embodiments. More specifically, the exemplary circuitry of the exemplary cooking appliance 10 may include an alternating current (AC) power source 26, a heating element 22, a shunt device or a dummy device 24 (collectively “shunt” or “shunt element”), and a rectifier 28, and the motor 18. In the exemplary schematic circuit diagram illustrated in FIG. 2, the heating element 22 and the shunt element 24 are connected in series to the AC power source 26. In some embodiments, a shunt element 24 may include a resistive element. In some of these embodiments, a shunt element 24 may include a heating element to provide additional heating in conjunction with the heat source 22

The rectifier 28 is devised to convert the AC power into a DC (direct current) power to drive the DC motor 18 that may, for example, further drive an impeller as described in FIG. 1. In this exemplary schematic circuit diagram illustrated in FIG. 2, the input terminals of the rectifier 28 are connected in parallel with the shunt element 24, and the combination is connected in series to the heat source 22. Heating element 22 functions as a voltage divider to reduce the AC voltage applied to the rectifier 28. Therefore, the rectifier 28 receives a low AC voltage and outputs a low DC voltage to the motor 18, compared with the AC voltage of the AC power source 26, which, by way of example, may be house hold AC supply source with a root mean square (RMS) voltage between 100 volts (V) and 240 V.

In some of the embodiments described herein, the rectifier 28 outputs DC power having a voltage of 36 V or lower. In some of these embodiments, the rectifier 28 outputs DC power having voltages with a range between 12 V and 36 V. In accordance with a preferred embodiment, the output voltage of the rectifier 28 is about 24 V. In these embodiments illustrated in FIG. 2, the motor 18 comprises a low voltage motor and thus may reduce or diminish the electric arcs or sparks at the commutator during the operation of the motor 18. The shunt element 24 serves to divert a portion of the current flowing through the heating element 22, thereby reducing the current flowing through the motor 18. Given the same diameter of wires for the field coil or field winding, the reduced electric current lowers the current density in the field coil or field winding and also lowers the Ohmic heating in the field coil or field winding.

In some of the embodiments described herein, the field winding or field coil of motor 18 may be made by wires having a diameter within a range from 0.2 millimeter (mm) to 0.5 mm. In some embodiments, the field coil or field winding of motor 18 may be made of electrically conductive wires having diameters larger than 0.5 mm to further reduce the Ohmic heating by the field coil or field winding due to further lowered current density.

In various embodiments described herein, a rectifier includes an electrical device that converts alternating current (AC) into direct current (DC). In some embodiments, the rectifier may include rectifiers of various types (e.g., a solid state rectifier, an electromechanical rectifier, etc.) In some other embodiments, a rectifier may include an SMPS (switching-mode power supply) with an AC input.

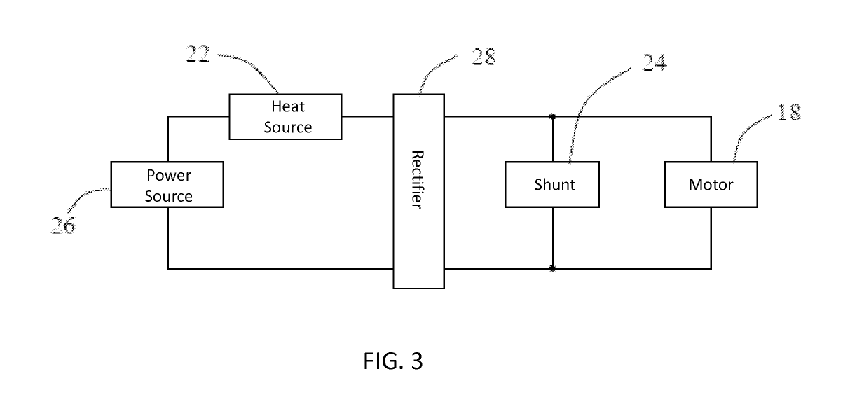

FIG. 3 illustrates another schematic circuit diagram of the exemplary cooking appliance 10 illustrated in FIG. 1 in some embodiments. More specifically, the exemplary circuit of the exemplary cooking appliance 10 may include an alternating current (AC) power source 26, a heating element 22, a shunt 24, a rectifier 28, and a motor 18. In the exemplary schematic circuit diagram illustrated in FIG. 3, the heating element 22 is connected in series to the AC power source 26. Heating element 22 functions as a voltage divider to reduce the AC voltage applied to the rectifier 28. Therefore, the rectifier 28 receives a lower AC voltage and outputs a lower DC voltage to the motor 18, compared with the AC voltage of the AC power source 26, which, by way of example, may be a household AC supply source with a root mean square (RMS) voltage between 100 volts (V) and 240 V.

The rectifier 28 is devised to convert the AC power into DC power to drive the DC motor 18 that may further drive, for example, the impeller 16 as illustrated in FIG. 1. In some embodiments, the rectifier 28 may include rectifiers of various types (e.g., a solid state rectifier, an electromechanical rectifier, etc.) In some other embodiments, the rectifier 28 may include an SMPS (switching-mode power supply) with an AC input. The shunt 24 is connected in parallel with the motor 18 on the direct current (DC) side of the rectifier 28 to provide control or adjustment for the electric current flowing through the motor 18. More specifically, the shunt 24 serves to divert a portion of the output electric current of the rectifier 28, thereby reducing the electric current flowing through the motor 18. With the same diameter of wires for the field coil or field winding for the motor 18, the reduced electric current lowers the current density in the field coil or field winding and thus also lowers the Ohmic heating in the field coil or field winding. In some embodiments, the shunt 24 may include a resistive element such as a resistor. For example, the shunt 24 may include a heating element or an electrical filament to provide additional heating in conjunction with the heat source 22 for preparing the food item.

In some of the embodiments described herein, the rectifier 28 outputs DC power having a voltage of 36 VDC or lower. In some of these embodiments, the rectifier 28 outputs DC power having voltages with a range between 12 VDC and 36 VDC. In accordance with a preferred embodiment, the output voltage of the rectifier 28 is about 24 V. In these embodiments illustrated in FIG. 3, the motor 18 comprises a low voltage direct current (LVDC) motor and thus may reduce or diminish the electric arcs or sparks at the commutator during the operation of the motor 18. In some of the embodiments described herein, the field winding or field coil of motor 18 may be made by wires having a diameter within a range from 0.2 millimeter (mm) to 0.5 mm. In some embodiments, the field coil or field winding of motor 18 may be made of electrically conductive wires having diameters larger than 0.5 mm to further reduce the Ohmic heating by the field coil or field winding due to further lowered current density.

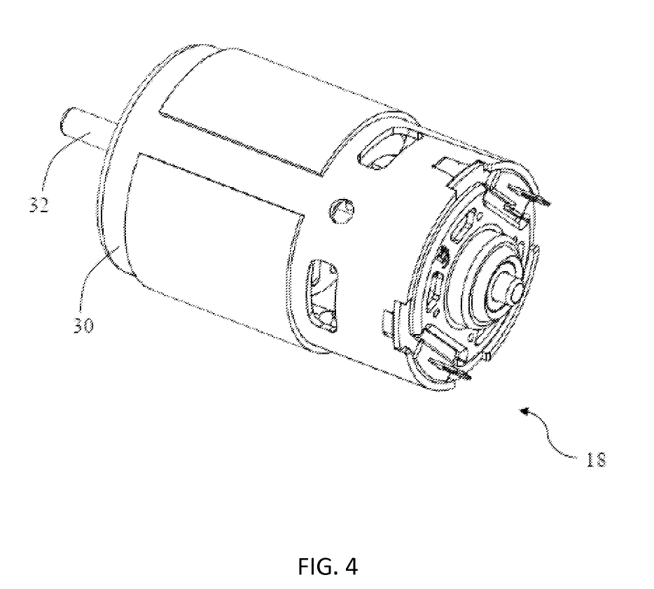

FIG. 4 illustrates a perspective view of a motor 18 in the exemplary cooking appliance 10 illustrated in FIGS. 1-3 in some embodiments. The exemplary motor 18 includes a stator 30 and a rotor 32. At least a portion of the rotor 32 is disposed within the stator 30 in some of the embodiments illustrated in FIG. 4. In these embodiments, the rotor 32 includes a shaft, an armature and a commutator fixedly attached to the shaft, and a field winding or a field coil wound on the armature. The stator 30 may include a stator housing and one or more permanent magnets disposed inside the stator housing in some embodiments. The stator housing includes an open end and a closed end in some of these embodiments.

The closed end of the stator housing may include one or more openings to allow air to flow into the stator housing to cool down the internal components (e.g., the field winding) by natural or forced convection in some embodiments. An end cap may be attached to the open end of the stator housing and may comprise multiple brushes in sliding contact with a commutator fixedly attached to the rotor shaft for commutation. In some of these embodiments, each of the closed end and the end cap may accommodate a bearing that rotatably supports the shaft. The end cap may further include electrical connectors electrically connected to an external power source, e.g., the rectifier 28 described herein above with reference to FIGS. 2 and 3.

In addition or in the alternative, various embodiments described herein may further include a protection circuitry including, for example but not limited to, a thermal transducer, a fuse, or a temperature sensor (hereinafter a temperature sensor collectively). The temperature sensor may be operatively coupled to at least a portion of the motor (e.g., an area on the external surface closer to the field winding of the motor or an area exhibiting highest temperature during motor operation) to protect the apparatus (e.g., a cooking appliance) or one or more components thereof from overheating in some embodiments. The temperature sensor may also be used to ensure the compliance of the cooking appliance with certain safety regulations, e.g., maximum temperature on the external surface to protect users of the apparatus from injuries caused by the users' accidentally touching certain portion of the apparatus.

The field winding or field coil may use a larger diameter wire due to the use of a low-voltage DC motor requiring a lower DC voltage and thus a higher electric current through the winding or field coil of the motor in these embodiments. A derivative advantage of using a larger diameter wire for the field winding or field coil is the resulting larger thermal mass and surface area for better dissipation of the heat generated by the operation of the motor. In some of the embodiments described herein, the wire used to form the field winding or field coil of the low voltage direct current motor (e.g., motor 18 of FIGS. 1-4) may have a diameter within a range from 0.2 mm (about 0.008 inch) to 0.5 mm (about 0.020 inch).

Another advantage of various embodiments described herein is that the ability to use a low-voltage DC motor having larger diameter wires for the field winding or field coil may reduce the current density flowing through the field winding

For example, the ability of using such a lowered DC voltage across the motor 18 enables various embodiments described herein to include a low-voltage DC motor, rather than using a high-voltage motor in conventional designs. The use of larger diameter wires in field winding or field coil of a low-voltage DC motor may the current density and the undesired Ohmic heating effects (due to lower resistance of the field winding with a larger diameter wire) and thus improves the reliability and life of the commutator due to lower operating temperature.

Another advantage of some of the embodiments described herein is that, with the same motor output and performance characteristics (e.g., the motor speed under the same load), the size of components (e.g., brushes, commutator, etc.) of the low-voltage DC motor may be reduced to provide more flexibility in incorporating the motor in an apparatus, integrating other components in the apparatus, reducing the overall size of the apparatus, and reducing the cost of production for the apparatus. For example, the size of the brushes or the commutator may be reduced due to less chance of arcing during commutation of the motor. Another advantage of some embodiments including a low-voltage DC motor in the design of an apparatus is that the lower DC voltage across the low-voltage DC motor reduces the possibility of electric arcing between the commutator and the brushes during commutation.

Electric arcing or arc discharge is an electrical breakdown of a gas (e.g., air) and occurs when the electric field between two non-contacting components becomes sufficiently strong to locally ionize the medium (e.g., air) in the vicinity and may thus cause ongoing plasma discharge at the presence of the electric field, although these two components are not physically contacting each other. Electric arcing may cause not only cosmetic, reliability, or performance issues but also physical damages to the components. By lowering the operating voltage across the voltage, the potential difference and thus the strength of the electric field between the commutator and the brushes is lowered during commutation to avoid the possibility of electric arcing. Therefore, the use of low-voltage DC voltages improves the reliability, performance, and life of the motor and thereby the overall apparatus including the motor.

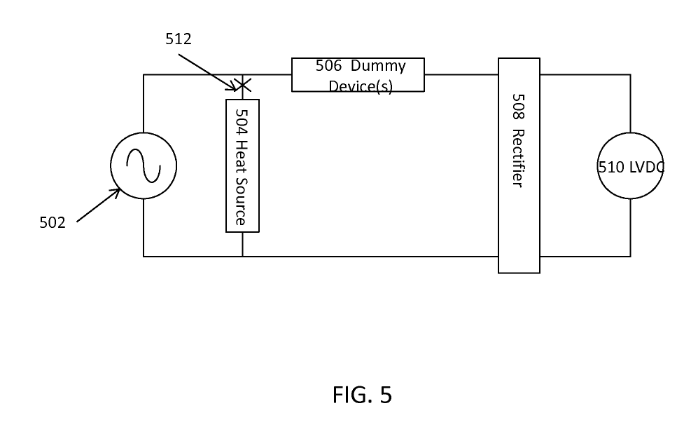

FIG. 5 illustrates another schematic diagram of a cooking appliance in some embodiments. The schematic diagram shows that the cooking appliance illustrated therein may include one or more heating elements 504 electrically coupled to an AC power source 502. Moreover, unlike the one or more heating elements 22 in FIGS. 2-3, the one or more heating elements 504 are directly connected across the AC power source 502.

The schematic diagram further includes one or more dummy devices 506 that may function as a voltage divider. The one or more dummy devices 506 are connected in series with the AC input of the rectifier 508 across the one or more heating elements or heat source 504 and thus may comprise one or more resistors, one or more capacitors, one or more inductors, or any combinations thereof. The rectifier 508 converts the AC power into a DC power to drive the electric motor 510. In some of these embodiments illustrated in FIG. 5, the electric motor 510 may include a low-voltage direct current (LVDC) electric motor. In some embodiments, the one or more dummy devices 506 may include one or more additional heating elements to provide additional heating either alone or in conjunction with the one or more heating elements 504 for preparing the food items. One of the advantages of a cooking appliance illustrated in FIG. 5 is that the one or more heating elements 504 are connected across the AC power source 502, and that the on or off state of the one or more heating elements 504 will not affect the operations of the remainder of the circuit. For example, the one or more dummy devices 506 may still receive power from the AC power source 502 to keep the food items in the cooking appliance 10 warm even when the one or more heating elements 504 are shut off from the AC power source 502. The electric motor 510 may still drive the impeller to, for example, prevent condensation from occurring inside the cooking appliance 10 even when the one or more heating elements 504 are shut off at the point “X” identified as 512. For example, a temperature sensor or a thermal protection circuitry may turn off the AC power to the one or more heating elements 504, while both the one or more dummy devices 506 and the electric motor 510 remain completely functional as designed. As a result, the electric motor 510 may continue to drive the impeller 16 so as to produce better quality food (e.g., crispier food), and the one or more dummy devices 506 may still provide heat to keep the food items in the cooking appliance 10 warm, while the one or more heating elements or heat source 504 are shut off.

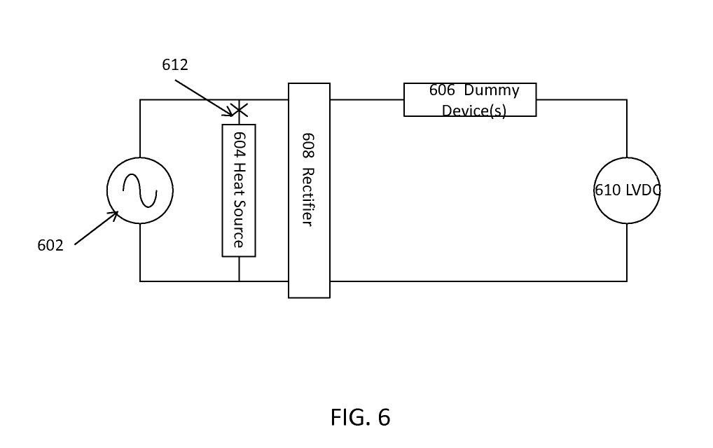

FIG. 6 illustrates another schematic diagram of a cooking appliance in some embodiments. Compared with the schematic diagram illustrated in FIG. 5, the schematic diagram illustrated in FIG. 6 includes the one or more dummy devices 606 on the DC side of the rectifier 608, whereas the one or more dummy devices 506 are situated on the AC side of the rectifier 508. Referring back to the schematic diagram illustrated in FIG. 6, the one or more heating elements 604 may be connected across an AC power source 602 and in parallel with the input of a rectifier 608 that converts the AC power from the AC power source 602 into DC power.

Similar to those illustrated in FIG. 5, the one or more heating elements or heat source 604 connected across the AC power source 602 may generate the maximum output power under the supply voltage of the AC power source 602. Similar to the one or more dummy devices 506 in FIG. 5, the one or more dummy devices 606 in FIG. 6 may further serve as a voltage divider to provide adjustment to the voltage for the electric motor 610.

Unlike the one or more dummy devices 506 in FIG. 5, the one or more dummy devices 606 in FIG. 5 are situated on the DC side of rectifier 608. As a result, the one or more dummy devices 606 may comprise one or more resistive elements. For example, the one or more dummy devices 606 may also include one or more additional heating elements with a lower power rating to provide additional heating for food preparation either alone or in conjunction with the one or more heating elements 604. Also similar to FIG. 5, the one or more heating elements 604 are connected across the AC power source 602, and thus the cooking appliance illustrate in FIG. 6 may exhibit identical or substantially similar advantages or benefits described immediately above for FIG. 5. For example, any events that result in shutting off the AC power into the one or more heating elements or heat source 604 at the point “X” identified as 612 will not affect the operations of the electric motor 610 or the one or more dummy devices 606.

1. A cooking appliance, comprising:
a heat source disposed within a housing of the cooking appliance and connected to an alternating current source external to the cooking appliance;
an impeller disposed in the housing and including an inlet and an outlet;
a rectifier having an input electrically coupled to the heat source and an output; and
a motor electrically connected to the output of the rectifier and mechanically coupled to the impeller.

2. The cooking appliance of claim 1, further comprising:
one or more first air passageways through a food process area in the housing and communicating with the outlet of the impeller and the heat source.

3. The cooking appliance of claim 1, further comprising:
one or more second air passageways communicating with the inlet of the impeller and the heat source disposed downstream of the impeller disposed between an internal sidewall of the housing and an external sidewall of a food container disposed within the housing, wherein at least a portion of the one or more second air passageways at least partially encloses the inlet of the impeller.

4. The cooking appliance of claim 1, further comprising:
a current shunt electrically coupled to the heat source and to the input of the rectifier.

5. The cooking appliance of claim 1, further comprising:
a current shunt electrically coupled to the output of the rectifier.

6. The cooking appliance of claim 1, further comprising:
a voltage divider having a first terminal electrically coupled to heat source and a second terminal electrically coupled to the input of the rectifier.

7. The cooking appliance of claim 1, further comprising:
a voltage divider having a first terminal electrically coupled to the output of the rectifier and a second terminal coupled the motor.

8. The cooking appliance of claim 1, further comprising:
a protection circuitry including a temperature sensor operatively coupled to the alternating current source and at least a portion of the motor.

9. The cooking appliance of claim 1, the motor comprising a low-voltage direct current motor having an input voltage in a range from 12 volts to 36 volts

10. The cooking appliance of claim 1, the rectifier having an output direct current voltage less than or equal to 36 volts.

11. The cooking appliance of claim 1, the motor further comprising:
a field winding wound on at least a portion of a rotor of the motor and comprising a wire having a diameter within a range between 0.2 millimeter (mm) and 0.5 mm.

12. The cooking appliance of claim 1, the heat source further comprising:
one or more heating components selected from a group consisting of one or more resistance heating elements, one or more lamps, one or more infrared heating components, one or more encapsulated heating elements, and a combination of two or more of the one or more resistance heating elements, the one or more lamps, the one or more infrared heating components, and the one or more encapsulated heating elements.

13. The cooking appliance of claim 1, wherein the impeller is disposed between an internal sidewall of the housing and an external sidewall of a food processing area within the housing.

14. The cooking appliance of claim 1, the cooking appliance selected from a group consisting of a convection oven, a convection microwave, a convection fryer, and a food dehydrator.

15. A convection cooking process, comprising:
electrically connecting a heat source disposed within a housing of a cooking appliance to an alternating current source;
converting an alternating current from the alternating current source to a direct current by electrically coupling an input of a rectifier to the alternating current source;
electrically coupling a direct current motor to an output of the rectifier;
driving an impeller with the direct current motor to circulate air flow past the heat source and through a food processing area in the housing of the cooking appliance; and
regulating an operating characteristic for the direct current motor.

16. The convection cooking process of claim 15, the act of regulating the operating characteristic for the direct current motor comprising:
electrically coupling a shunt in parallel with the direct current motor to the output of the rectifier.

17. The convection cooking process of claim 15, the act of regulating the operating characteristic comprising:
electrically coupling a shunt in parallel with the input of the rectifier to the heat source.

18. The convection cooking process of claim 15, the act of regulating the operating characteristic comprising:
electrically coupling a voltage divider in series with the input of the rectifier to the heat source.

19. The convection cooking process of claim 18, the act of electrically coupling a voltage divider comprising:
selecting the voltage divider from a group consisting of a resistive device, a capacitive device, an inductive device, and a combination of two or more of the resistive device, the capacitive device, and the inductive device.

20. The convection cooking process of claim 15, further comprising:
guiding the air flow through one or more first air passageways communicating an outlet of the impeller and the heat source, at least a portion of the one or more first air passageways situated between an internal sidewall of the housing and an external sidewall of a food processing area within the housing; and
guiding the air flow through one or more second air passageways that enclose at least a portion of an inlet of the impeller.
